(19) United States
(12) Patent Application Publication
(10) Pub. No.: US 2004/0036197 A1
(43) Pub. Date: Feb. 26, 2004

(54) Methods of forming molded, coated wood composites

(76) Inventors: Eugene R. Janiga, Naperville, IL (US); Geoffrey B. Hardwick, St. Charles, IL (US); Bei-Hong Liang, Naperville, IL (US); John Peter Walsh, St. Charles, IL (US)

Correspondence Address: Joseph W. Berenato, III, Liniak, Berenato, Longacre & White, LLC, Ste. 240, 6550 Rock Spring Drive, Bethesda, MD, 20817, US

(21) Appl. No.: 10/224,585

(22) Filed: Aug. 21, 2002

(51) Int. Cl. B29C 31/00

(52) U.S. Cl. 264/322

(57) ABSTRACT

A method of making a coated, molded cellulosic fiber board, including the steps of: applying a primer composition comprising a polymer to a surface of an already-compressed cellulosic fiber board, the composition formulated to form a chemically crosslinked polymer matrix when applied to the board; treating the board with steam; heating the board to its thermal softening point, wherein the wood fiber material of the board is plastically deformable; and pressing the treated, primed board into a desired shape, is disclosed.

### BACKGROUND OF THE INVENTION

1. Field of the Invention

The invention generally relates to the production of molded, coated cellulosic fiberboard. More particularly, the invention relates to a method of producing a molded, coated cellulosic fiberboard from a pre-consolidated cellulosic fiberboard mat.

2. Brief Description of Related Technology

Consolidated cellulosic articles, such as hardboard, softboard, medium-density fiberboard (MDF), low-density fiber board, and paper board are typically comprised of wood furnish such as saw dust, shavings, or fibers made by grinding or explosion hydrolysis, which are formed into a loose mat with a binding agent or resin and then compressed under heat and pressure. Such boards can be used in a variety of applications such as interior and exterior panels and pegboard. Such boards, particularly hardboard, also have found widespread use in the manufacture of door skins, which can be glued together or laminated to support or enclose a structure or a frame.

Commonly, such boards are molded from a planar cellulosic mat and can be formed to include one or more interior depressions or contours (as in the case of a door skin), such as one or more square or rectangular depressions which do not extend to the outer edge or periphery of the article.

The principal processes for the manufacture of wood composites such as door skins and other structural or building products include (a) wet felted/wet pressed or “wet” processes, (b) dry felted/dry pressed or “dry” processes, and (c) wet felted/dry pressed or “wet-dry” processes.

Generally in a wet process, cellulosic fillers or fibers (e.g., woody material which is subjected to fiberization to form wood fibers) are blended in a vessel with large amounts of water to form a slurry. The slurry preferably has sufficient water content to suspend a majority of the wood fibers and preferably has a water content of at least 90 percent by weight (“weight percent” or “wt. %”). The slurry is deposited along with a synthetic resin binder, such as a phenol-formaldehyde resin, onto a water-pervious support member, such as a fine screen or a Fourdrinier wire, where much of the water is removed to leave a wet mat of cellulosic material having, for example, a moisture content of about fifty weight percent. The wet mat is transferred from the pervious support member to a press and consolidated under heat and pressure to form the molded wood composite.

A wet-dry forming process can also be used to produce wood composites. Preferably, a wet-dry process begins by blending cellulosic or wood fiber raw material in a vessel with large amounts of water having a pH of less than 7 to form a slurry. This slurry is then blended with the resin binder. The blend is then deposited onto a water-pervious support member, where a large percentage (e.g., 50 percent or more) of the water is removed, thereby leaving a wet mat of cellulosic material having a water content of about 40 wt. % to about 60 wt. %, for example. This wet mat is then transferred to an evaporation zone where much of the remaining water is removed by evaporation. The dried mat preferably has a moisture content of less than about 10 wt. %. The dried mat is then transferred to a press and consolidated under heat and pressure to form the wood composite which may be, for example, a flat board, a door skin, or any other desired shape depending on the intended use of the product.

In a dry process, the cellulosic fibers are generally conveyed in a gaseous stream or by mechanical means rather than a liquid stream. For example, the cellulosic fibers may be first coated with a thermosetting resin binder, such as a phenol-formaldehyde resin. The fibers are then randomly formed into a mat by air blowing the resin-coated fibers onto a support member. The mat may optionally be subjected to pre-press drying. The mat, typically having a moisture content of less than 30 wt. % and preferably less than 10 wt. %, is then pressed under heat and pressure to cure the thermosetting resin and to compress the mat into an integral consolidated structure.

A fiber mat formed by the above-described methods can be pressed into a pre-selected shape, for example at a thickness of about one-eighth of an inch. In the case of a composite door skin product, the shape generally includes one or more panels and/or other contours in the door skin. The boards also can be provided with a wood grain pattern by using a mold with a complementary relief pattern. Two door skin pieces are typically joined to a frame with an adhesive binder, which is placed at least at the contact points along the periphery of the door assembly formed by the door skins. Because the door skin pieces are contoured, an open, interior space of varying dimensions is formed by the door skin assembly.

The consolidated cellulosic board is typically painted with one or more primer layers after consolidation, and most typically before assembly. The primed article is then painted with a top coat or stained. As a result, any wood grain pattern formed in the board is at least partially obscured by primer or paint that fills the pattern in the board. In alternative processes according to Hsu et al. U.S. Pat. No. 5,635,248 (Jun. 3, 1997) and Chen et al. U.S. Pat. No. 6,165,308 (Dec. 26, 2000), one or more coating layers can be provided on a compressible fiber mat prior to pressing to form a coated, consolidated cellulosic board.

In a completely different method of forming a molded consolidated cellulosic article, an already-consolidated, planar fiber board is molded. Use of an already-consolidated fiber board, such as MDF, has the advantage that it is easily transported and stored, and can be purchased from a variety of sources and molded in locations remote from the source of wood used to make the fiber board. Thus, international patent publication WO 98/48922 (Nov. 5, 1988) teaches that an already-consolidated planar fiber board can be treated such that the material of the board reaches its thermal softening point, and then deformed in a press to form complicated shapes with considerable differences in height (e.g., deep molded). Such molded boards can be provided with a wood grain pattern by using a mold with a complementary relief pattern. To avoid traditional finishing operations, international patent publication WO 98/48922 teaches that the molded boards can be provided with a synthetic melamine surface by arranging a sheet of melamine-impregnated paper on top of the treated fiber board, and joining the sheet and the board during the pressing step.

Accordingly, It would be desirable to have a method of forming molded fiber board articles with deep-molded features from already-consolidated fiber boards without having to prime and paint the boards in distinct, separate manufacturing steps, and to retain the accuracy and detail of a wood grain pattern formed therein.

### SUMMARY OF THE INVENTION

It is an objective of the invention to overcome one or more of the problems described above.

Accordingly, one aspect of the invention is a method of making a coated, molded cellulosic fiber board, including the steps of: applying a primer composition comprising a polymer to a surface of an already-compressed cellulosic fiber board, the composition formulated to form a chemically crosslinked polymer matrix when applied to the board; treating the board with steam; heating the board to its thermal softening point, wherein the wood fiber material of the board is plastically deformable; and pressing the treated, primed board into a desired shape.

Further aspects and advantages of the invention may become apparent to those skilled in the art from a review of the following detailed description, taken in conjunction with the appended claims. While the invention is susceptible of embodiments in various forms, described hereinafter are specific embodiments of the invention with the understanding that the disclosure is illustrative, and is not intended to limit the invention to the specific embodiments described herein.

### BRIEF DESCRIPTION OF THE DRAWINGS

FIG. 1 depicts the profile of a molded, coated cellulosic fiber board formed according to a method disclosed herein.

### DETAILED DESCRIPTION OF THE INVENTION

The invention is directed to a method for molding and coating (e.g., with a primer) an already-consolidated cellulosic (e.g., wood-derived) fiber board, such as MDF, into complicated shapes with considerable differences in height between major and minor planes formed by the molded board. The methods disclosed herein take advantage of a process of extrusion (e.g., as described in international patent publication WO 98/48922, the disclosure of which is incorporated herein by reference), whereby considerable plastic deformation, accompanied by flow and stretch of the cellulosic material and one or more coating compositions takes place. The methods disclosed herein also take advantage of coatings (e.g., primer, top coat, and mold release compositions) such as those disclosed in U.S. Pat. No. 6,165,308 (Dec. 26, 2000), described in detail below and incorporated herein by reference.

Generally, the method includes the steps of applying a primer composition including a polymer to a surface of an already-compressed cellulosic fiber board, the composition formulated to form a chemically crosslinked polymer matrix when applied to the board; treating the board with steam; heating the board to its thermal softening point, wherein the wood fiber material of the board is plastically deformable; and pressing the treated, primed board into a desired shape. Preferably, the primer composition is applied to the board prior to the steam treatment step. Optionally, one or more additional compositions, such as top coats and mold release compositions, can be applied over the primer composition.

By execution of the methods disclosed herein, the fiber board will be considerably plastically deformed, and a primer coating suitable for staining or finishing will be provided. The terms “coat” and “coating” are used herein for with respect to the preferred embodiments, however it is recognized that such compositions can be applied to the fiber board by various means in addition to spray, roll, and curtain coating, such as lamination. Furthermore, the terms “coat” and “coating” are not limited to a uniform or continuous layer of composition, although continuous coatings are advantageous in the most common applications of the methods described herein.

The thermal softening point and the maximum thermal softening which can be attained in an already-compressed cellulosic fiber board are a function of the wood species and the chemical properties of the board material. Also important are the cellular moisture content and the quantity of heat supplied. Softening at as low as possible a temperature is favorable.

The selection of a favorable fiber board substrate can be made experimentally by establishing for a test piece the thermal softening point and the degree of thermal softening at that point. Material made of a wood fiber with long fibers is preferred. Soft woods are also preferred. In particular, pine is very suitable to be used as basic material, such as radiata pine, in which thermal softening begins at 95° C. To achieve the greatest advantages in convenience, commercially-available commodity fiber board, such as MDF, can be used.

The density of the already-condensed fiber board will influence not only the handling characteristics of the board both before and after coating and steam treatment, but also the amount of coating that must be applied. The already-condensed fiber board will be at least a low-density fiberboard (e.g., density in the range of about 10 lb/ft³ to about 30 lb/ft³), and preferably MDF (e.g., density in the range of about 30 lb/ft³ to about 50 lb/ft³). In one preferred embodiment the fiber board substrate will have a density in the range of about 35 lb/ft³ to about 60 lb/ft³, more preferably about 45 lb/ft³ to about 55 lb/ft³.

Preferably, the fiber board substrate can have a relatively high moisture content prior to application of one or more coatings and steam treatment, such that the further addition of water in the steam treatment step is correspondingly less, and the time of treatment is thus shortened. The amount of moisture content in the fiber board substrate prior to application of one or more coatings and steam treatment can vary with the amount of steam treatment and the pressing cycle to result in a coated, molded fiber board that has the desired final moisture content.

In a preferred embodiment of the method, the fiber board substrate will incorporate a binder that is not fully hardened (e.g., cured), such that the binder can be further cured (or fully cured) during and/or subsequent to the process of deformation and molding. A resin binder is preferred, such as urea formaldehyde, melamine-urea formaldehyde, phenol formaldehyde, and melamine-urea phenol formaldehyde. Resins that are moisture-resistant (e.g., resistant to degradation via contact with water), such as melamine-urea formaldehyde and methylene diphenyl diisocyanate, are most preferred.

One or more coating compositions (e.g. primer, top coat, and mold release compositions) can be applied to the fiber board by any known process. Because uniformity and consistency in application of primer can result in conservation of primer material and a better looking finished product, spraying methods are preferred (i.e., airless, air-assisted, and air spraying). Other suitable methods include roll coating and curtain coating. In one embodiment of the invention, the primer composition can be formed in a separate sheet, which is then heat bonded (e.g., laminated) to the fiber board during pressing.

Preferably, the primer composition is applied to the board prior to the steam treatment step. In this embodiment, the method of the invention can be readily adapted to existing production lines that operate according to the description in international patent publication WO 98/48922. In addition, in this embodiment, the time between removal of a board from a steam chamber and introduction into a mold is reduced, which advantageously reduces the amount of heat and moisture lost by the board between the treatment and pressing steps. Optionally, a fiber board can be steam treated, coated, and then further steam treated.

In one embodiment, a primer composition is air sprayed onto one major surface of a fiber board, and then a top coat composition is sprayed over the primer composition. Optionally, the board can be left to air dry between sprayings and after application of the top coat. Thus, when it is desired to prepare multiple boards with one or more coatings and to press the boards in a remote location, preferably the boards are left to air dry after application of all coatings such that the boards can be stacked and shipped. The rate of drying of the coatings can be assisted, such as by convection and radiation.

An appropriate amount of each coating applied to a fiber board will vary depending on the particular coating composition used (including the nature of the primer composition, the crosslinking chemistry, and the solids content of the primer), the degree of deformation of the fiber board (e.g., the increase in surface area of the board and the coating), the composition and density of the cellulosic fiber board itself, and the end use of the coated, molded board.

Due to the relatively high density of the fiber board substrate, the amount of primer composition can be very small. Generally, the amount of primer composition will be in the range of about 0.2 dry mil to about 4.5 dry mil, preferably about 2 dry mil to about 3 dry mil for a door skin.

Generally, when the primer composition is formulated as a polymer latex utilizing pH dependent coacervation chemistry or ionic crosslinking chemistry, the primer can be applied at a rate of about 7 wet g/ft² to about 40 wet g/ft², preferably about 15 wet g/ft² to about 25 wet g/ft². Likewise, a top coat composition, if used, preferably is applied in an amount generally less than that of the primer, and typically less than one-half that of the primer, for example, about 0.5 wet g/ft² to about 10 wet g/ft², more typically about 3 wet g/ft² to about 7 wet g/ft². A release coat composition, when used, typically is applied at minimum usage levels sufficient to facilitate release of the coated, molded board from the mold. Thus, a release coat can be applied at about 3 g/ft² or less, for example, and preferably about 1 g/ft² or less. Use excessive amounts of release agents may adversely affect adherence of finish coatings to the surface of the coated, molded board.

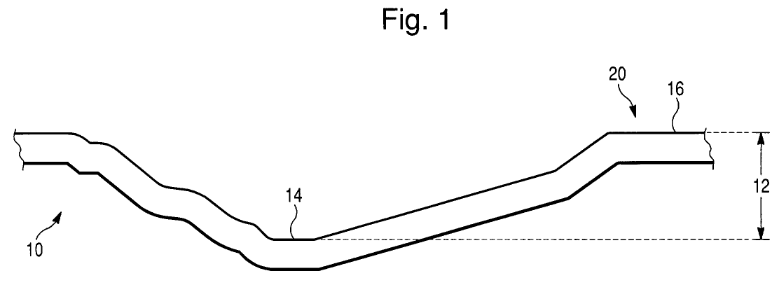

For the particular preferred primer described below, at least about 1 dry mil to about 3 dry mil, preferably at least about 2 dry mil (e.g., 2.5 dry mil, equivalent to about 12 dry g/ft²), is applied to a ⅛ inch (3.8 mm) nominal MDF board molded to have a profile shown in FIG. 1, for example. Similarly, for the particular preferred release coat described below, at least about 0.2 dry mil is applied over the primer coat, more preferably at least about 0.3 dry mil (e.g., 0.34 dry mil, equivalent to about 1 dry g/ft²). The use of more primer or top coat composition can serve to cover fine lines and cracks that can occasionally appear in an otherwise useful molded board.

Depending on the hiding power (i.e., the ability to hide the previous surface color) of the primer composition, more primer may be necessary to provide a uniform color appearance on the molded board. Similarly, if the top coat composition is used to provide color or hide, the amount used will generally depend on aesthetic requirements. If the outermost coating is at least in part a mold release coating, then the amount used will generally be an amount sufficient to provide a uniform coat on the board, and can also depend on the ability of the composition to resist sticking to the heated mold.

The steam treatment, during which the board material acquires a softened state, preferably takes place in an at least partially closed steam chamber. Preferably, the chamber is closed off hermetically and filled with steam to penetrate the cellulosic fiber board so that the board absorbs moisture and heat. Optionally, vacuum pumps can be used to create a partial vacuum (e.g., about 0.8 bar) inside a steam chamber after a board has been received in the chamber and the latter has been closed. When a suitable underpressure has been reached, steam from a boiler is introduced into the chamber. Due to the steam supplied the pressure inside the chamber will rise again to approximately atmospheric pressure and at the same time the steam will also quickly penetrate the pores of the cellulosic fiber board. The greater the underpressure in the steam chamber prior to the supply of steam, the shorter can be the duration of the treatment of a board.

In one embodiment of an apparatus useful for steam treatment, the steam exhaust in the chamber consists of a number of nozzles arranged in the bottom of the chamber pointing upwards, which introduce the supplied steam below an uncoated side of the board. As a result (and together with the sucking action due to relieving underpressure when a vacuum step is used), penetration of the steam is achieved.

Preferably, the steam is generated at a pressure of several bars, preferably more than 10 bars. Due to the expansion of the steam in the chamber, the temperature of the steam will drop to just above 100° C. and some of the steam will rapidly condense inside the board. The board is then both heated and moistened.

In one embodiment of an apparatus useful for steam treatment, the walls of the steam chamber are themselves heated, e.g., by supplied steam. Thus, in addition to a board being heated by direct contact with the steam, a board inside the steam chamber is also heated because the walls of the chamber give out heat to the board by means of radiation.

Formation of water drops on the boards in the steam chamber can result in defects in the final product, such as blistering in the coatings if a board is coated prior to steam treatment. By heating the portions of the steam chamber above the board to substantially the same temperature as the steam used for expansion, condensation and release of water droplets on the board can be prevented. The interior surfaces of the steam chamber can be maintained at a temperature above 100° C. by using hollow steam chamber walls in which steam at elevated pressure is circulated.

By way of compensation for the loss of heat during transport of a board from the steam chamber to the press, the board is heated as much as possible in the steam chamber, but not so high that it would become too weak to be handled when it has to be positioned inside the press. A temperature of about 100° C. is preferred for MDF board with a thickness of about 3.8 mm made of radiata pine wood fiber.

The amount (e.g., duration) of steam treatment and, thus, the amount of moisture absorbed will depend on the degree of deformation of the fiber board (e.g., the increase in surface area of the board and the coating), the composition, density, and beginning moisture content of the substrate fiber board itself, the press cycle, and the desired finished moisture content of the coated, molded board (i.e., depending on the end use of the article). Typically, the degree of steam treatment will be an experimentally-determined variable, based on the conditions just listed to achieve the desired moisture content in the finished article. In the alternative, a fixed degree of steam treatment (sufficiently high to allow the desired degree of deformability of the board but sufficiently low to retain the necessary handling properties for transfer into the mold) can be used, and the press cycle can be altered to achieve the desired moisture content in the finished article.

Generally, the duration of steam treatment will be in a range of about 20 seconds to about 3 minutes. It has been found that for a ⅛ inch nominal MDF fiber board with a beginning moisture content of about 8 wt. %, a desired finished moisture content of about 7 wt. %, a finished profile having a depth of draw of about 9 mm, and a press cycle of about 1 minute at about 150° C., the board is preferably treated for about 30 to about 90 seconds in a steam chamber of approximately atmospheric pressure (with no vacuum step).

In a preferred embodiment, after steam treatment a coated cellulosic fiber board is subjected to extrusion and molding in a press. To achieve maximum deformation during the pressing, careful control of the pressing cycle and specific design features of the mold cavity (i.e., space formed, for example, by upper and lower mold dies) are important, in addition to the choice of the fiber board material and the degree of softening.

The total surface area of a molded, coated article made according to a method disclosed herein is larger than that of the fiber board used as a starting material. To form molded profiles, such as that shown in FIG. 1, material in the board is moved between adjoining locations in the board. Likewise, to keep the molded profiles coated, material in each coating is moved between adjoining locations.

An important feature of the invention is controlling the movement of the fiber board material and coating material(s) during extrusion while pressing. By means of mold design features described in international patent publication WO 98/48922 (Nov. 5, 1988), it is ensured that the direction from which the material during pressing flows towards a molded profile is controlled (see also FIG. 1).

Preferably, the mold dies will be heated and, consequently, the board and coating(s) being molded are heated. In the narrowest sections of the mold cavity, the first contact between the heated dies and the coated board takes place, as a result of which these areas are heated first and for the longest time. The plasticity of the board and coating(s) increases due to the increase in temperature, which contributes to the required flow of the materials during pressing.

An additional effect of constrictions in the cavity of a mold is that fibers which may have become debonded in the steam treatment step or during early stages of pressing are subsequently pressed under great pressure into the surface of the molded board. The suitable cellulosic fiber boards for use in the invention, such as MDF boards, include a binding agent which usually is not fully hardened (e.g., cured) before use in a method disclosed herein. Due to the pressure and heat applied, further hardening of this binding agent will take place, whereby in the state following extrusion the wood fibers will be bonded well. Fibers which may have become debonded at one or more surfaces following movement of cellulosic material are bonded once again firmly to the interior material in this manner.

As disclosed in international patent publication WO 98/48922 (Nov. 5, 1988), the position of local constrictions or movable mold parts obviously depends on the shape to be extruded. When designing this shape it should often already be possible to determine where the most critical sections are located and determine based on that where the board and coating(s) to be extruded has to be retained in order to control the flow of material. When, during trial pressings, it becomes apparent that damage due to incorrect movements of material occurs in certain areas, the mold can be adjusted accordingly. Considering the above, these adjustments are within the capabilities of a person of ordinary skill in the art.

FIG. 1 depicts the profile of a molded, coated cellulosic fiber board 10 formed according to a method described in the Examples below. The profile is a useful feature in a decorative door panel. As shown in the figure, the fiber board 10 is deformed to be deeply molded. In other words, the fiber board 10 has a depth of draw 12 such that the surface of one side of the molded board 10 at its lowest point (e.g., surface 14) is lower than the opposite surface of the board 10 at a point (e.g., surface 16) in the major plane of the board 10 (e.g., a non-deformed portion 20 of the board). Put another way, the depth of draw 12 is greater than the caliper thickness of the board 10 at a point in the major plane of the board (e.g., portion 20), for example. According to the methods disclosed herein, an already-compressed fiber board can be deep molded to a depth of draw of up to about 12 mm, for example, preferably up to about 9 mm for a door skin with a final caliper of about 0.125 inches (about 3.2 mm). It is very unexpected that an already-compressed cellulosic fiber board can be deeply-molded and provided with a coating in the same process, without fracturing, tearing, or blistering the coating.

Besides the features described above which enable extrusion of a coated cellulosic fiber board with a very complicated shape, improved quality of a coated, molded board can be attained by controlling the pressing cycle as well.

A pressing cycle begins when a treated cellulosic fiber board and applied coating(s) has been positioned inside a mold (e.g., between a set of mold dies). At that moment, a press will close, preferably very rapidly, until both parts of the mold (e.g., dies) start to make contact with the board. Next, the mold closes very slowly until it is closed completely to deform the fiber board material by the application of pressure to the desired shape formed by the closed mold. The mold is held closed for a period of time, followed by the release of pressure and the escape of moisture in the form of steam from the board. The pressing cycle is complete when the mold is opened and the molded board is removed.

The mold closes rapidly during the first part of the closing cycle to achieve as short a cycle time as possible and for the treated, coated board to retain heat. The subsequent slow pressing part of the closing cycle can be beneficial to extrusion of the materials during pressing and deformation. During and subsequent to the slow closing of the mold and deformation of the coated board, strains built up in the material are equalized and at the same time heating of the coated board takes place due to contact with the heated mold parts, as a result of which the deformability of the materials increases again. Preferably, the closing of the mold is paused one or more times before the mold is fully closed to allow built up strains to equalize.

In one pressing cycle according to the methods disclosed herein, when the mold is closed completely, the applied pressure is maintained for a certain period of time, after which the pressure is reduced to nearly zero and is applied again after some time. This sequence can be repeated once again. When the applied pressure is reduced for the third time, the mold is opened and the coated, molded board will be ready to be removed from the mold.

In another pressing cycle according to the invention, preferred for coating and molding ⅛-inch nominal MDF, the mold is slowly closed over a period of about 10 seconds to about 20 seconds, with one or more brief pauses during closing, the press is held completely closed for a period of about 20 seconds to about 40 seconds, and then the press is slowly opened for decompression over a period of about 10 seconds to about 20 seconds.

Preferred pressing cycles will depend on the profile formed in the coated board and the type of cellulosic fiber in board. In general, the closing speed will be minimal or close to zero when the most crucial parts of the profile are being formed. A closing speed which is too high during the molding phase concerned may be detectable in the final product because material defects, mainly visible at the surface, can occur. Such material defects can, for example, be loose fibers, uneven surface sections, and ripples, blisters, or tears in the coating.

An appropriate closing cycle can be established experimentally, the premise being that the speed should be low or close to zero when the deformation caused by the activated mold involves maximal material strain. Put another way, the closing speed preferably is in inverse proportion to the degree of material strain. Thus, when the strain is high, the closing speed is slow, and when the strain is low, the closing speed can be increased. In addition, there should be sufficient time for heat transfer from the mold dies to sections of the material which are to be deformed significantly to maintain the temperature of those sections at least at the thermal softening point.

Generally, the pressure applied in the mold can be in a range of about 500 psig (about 35 kf/cm2) to about 1600 psig (about 110 kg/cm2). If the treated, coated board contains less moisture and/or more binder, then higher pressures are preferred. Similarly, if the treated, coated board contains more moisture and/or less binder, then lower pressures are preferred.

In one embodiment, the maximum pressure is just over 60 kg/cm² (about 850 psig), but in many cases a lower pressure will suffice, such as about 40 kg/cm² (about 570 psig) for a cellulosic fiber board with an initial thickness of about 3.8 mm to about 3.2 mm, plus one or more coatings. In that case, the entire board is heated to about the temperature of the mold dies.

Due to the pressure decrease in the pressing cycle, the water in the board material, which has been heated above the atmospheric boiling point, will suddenly become steam, and this steam will escape though the fiber board sideways between the molds. With subsequent applications of pressure, the applied pressure can be increased again to the maximum value employed and kept at this level for a time, whereby the still remaining water is heated again. A portion of this water will escape once again the next time the pressure is reduced. After the mold has been opened for the final time, the moisture content of the coated board has fallen to a very low value in comparison to the moisture content of the coated, treated board.

The drying and degassing cycle described herein takes place while the mold parts remain in close contact with the two major surfaces of the board material and/or the primer composition theron. Thus, surface defects such as debonding of surface fibers and formation of blisters due to the expansion of the water are minimized or prevented. Because the pressure does decrease but the mold parts do not move in relation to one another, the board remains supported over its entire surface area, as a result of which no substantial movement of wood fibers or coating compositions due to the water vapor pressure can take place.

At least one, and often two or three drying-degassing steps will be required, depending on the water content of the material, the temperature of the mold and other properties of the material. For an article, such as a door skin, exposed to high- and low-humidity environments, the moisture content of the finished board can have a bearing on the structural properties of the board and the finish quality of the coating on the board. This is because a door skin, for example, can absorb moisture in the summer months to increase to as much as about 14 wt. % water, and decrease in the winter months to as little as about 2 wt. %. If the coated, molded article is made to have a moisture content in the middle of this range, then the deviation in water content during high- and low-humidity periods will be minimized. Consequently, the possibilities of warping and delamination from a door frame, for example, are minimized.

Thus, for example, in a ⅛ inch nominal MDF coated with the preferred compositions identified below, the moisture content of the finished board preferably is less than about 8 wt. % for good finish quality of the coating. To prevent warping, for ⅛ inch nominal MDF coated on a single side, the moisture content preferably is in a range of about 5 wt. % to about 9 wt. %, more preferably about 6 wt. % to about 8 wt. %. Boards made with stronger resins or used in controlled-humidity environments can, of course, be made to practically any moisture content below about 10 wt. %.

The overall closing cycle, depending on the complexity of the profile, for example, can be very short (e.g. 60 seconds). For example, the time to effect a slow close can be about 15 seconds, pressure can be applied over 10 seconds, then released and reapplied for another 20 seconds, and finally the mold can be decompressed and opened in about 15 seconds.

Preferably, the operating temperature of the mold is about 250° F. to about 450° F. (about 120° C. to about 230° C.). When using the preferred coatings identified below, the mold temperature preferably is about 280° F. to about 320° F. (about 140° C. to about 160° C.) for ⅛ inch nominal MDF. The temperature variation over the total working area of the press preferably is within about 4° F. (about 2° C.). The sections of the press carrying the mold dies can be heated by means of thermal oil, for example. To achieve the most accuracy in temperature distribution, conduits preferably are arranged along the entire length of the platens through which the thermal oil flows in a parallel fashion, for example.

As disclosed in international patent publication WO 98/48922, the mold can be fashioned to form multiple articles, same or different, in a single pressing cycle by using multiple sets of upper and lower dies.

Preferably, a fast-setting, formaldehyde-free primer composition is the first coating applied to a surface of a fiber board. The primer is formulated to form a chemically crosslinked polymer matrix (e.g., a 3-dimensional gel) when or as it is applied to the surface. The fast-setting primer preferably exhibits excellent hold out characteristics (i.e., the ability, and/or a property to prevent, the primer itself and/or subsequent coatings from soaking into the fiber board), produces a smooth surface of low porosity. In addition, the primer exhibits physical characteristics such as low porosity, surface smoothness, surface hardness, and flexibility. The primer coating also exhibits favorable chemical properties, including excellent blocking resistance (i.e., low tackiness), resistance to moisture, and good adherence to applied finish coating compositions (e.g., conventional paints, stains, and the like).

The primer generally comprises either a thermosetting polymer or a thermoplastic polymer and is otherwise formulated for rapid crosslinking/gel formation upon application to the surface of a cellulosic fiber board. In one embodiment of the invention, the primer is formulated to undergo ionic crosslinking upon application to the fiber board. In one preferred embodiment the primer comprises an anionically-stabilized thermoplastic latex which undergoes a gel-forming pH dependent, ionic crosslinking reaction as it is applied to the surface of the board. Alternatively, the primer composition can be a two-component composition wherein the first and second components are capable of gel formation through ionic crosslinking when applied, for example, through a dual channel sprayer.

In one embodiment of the invention, the top coat composition is a thermosetting latex composition which improves surface properties of the coated board and facilitates release of the coated, molded board from the heated mold. The top coat preferably is a formaldehyde-free, low-temperature thermoset coating that functions both as a releasing agent and as an anti-metal-mark coating.

In yet another embodiment of the invention a release coat composition comprising a repaintable silicone polymer or a surfactant is applied over the primer coating to facilitate release of the coated, molded board from the mold.

Any of a wide variety of polymer latexes, either as single or two-component compositions, can be utilized in a primer, provided that such are formulated to provide a fast set chemistry that enables rapid chemical crosslinking of the polymer as it is applied to the fiber board. The primer composition can be formulated so that the crosslink bonding can occur rapidly via ionic or covalent bonding as it is applied to the board. Thus, in one embodiment of the invention the primer is formulated to form an ionically crosslinked polymer matrix when applied to the surface of the fiber board. Such coating compositions are known in the art. Examples of compositions formulated for fast setting via ionic crosslinking of polymer components are those described in international application PCT/US96/00802, published as international publication WO 96/22338 (Jul. 25, 1996), the disclosure of which is incorporated herein by reference. The aqueous coating composition described in that publication includes from 95 wt. % to 99 wt. %, based on the weight of dry materials in the composition, of an anionically-stabilized aqueous emulsion of a copolymer having a glass transition temperature (Tg) in the range −10° C. to 50° C. The copolymer comprises in polymerized form a polymerization mixture containing two or more ethylenically-unsaturated monomers, wherein, based on the total weight of all ethylenically-unsaturated monomers in the polymerization mixture, from 0 wt. % to 5 wt. % of the monomers are alpha, beta-ethylenically-unsaturated aliphatic carboxylic acid monomers; from 0.2 wt. % to 5 wt. % of a polyimine having a molecular weight of from 250 to 20,000; and from 0.2 wt. % to 5 wt. % of a volatile base; wherein the composition has a pH from about 10.3 to about 12, more typically about 8 to about 11, and wherein a cast film of the composition has a hardening rate measurement rating of at least 5 within 20 minutes after casting under ambient conditions of temperature up to 30° C. and relative humidity no less than 50%. The fast set latex composition can also be formulated to include standard coating excipients such as defoamers, wetting agents, dispersants, release agents, pigments and fillers, such as organic fillers, inorganic fillers, organic fibers, inorganic fibers, and combinations thereof. The composition is optionally pigmented and is described as particularly useful as a fast hardening aqueous traffic paint.

The volatile base component of the fast set latex includes an organic or inorganic compound which is a weak or strong base, or which has sufficiently high vapor pressure and tendency to evaporate or otherwise volatilize out of the aqueous coating composition, thereby engendering a reduction in pH and concomitant ionic crosslinking of the polyimine and carboxy polymer components of the composition. Examples of volatile bases include ammonium hydroxide and organic amines containing up to four carbon atoms, including, for example, dimethylamine, diethylamine, aminopropanol, ammonium hydroxide, and 2-amino-2-methyl-1-propanol, with ammonium hydroxide being most preferred. The volatile base typically comprises about 0.3 wt. % to about 1.5 wt. % of the coating composition. One polymer coating composition utilizing such chemistry is commercially available from the Dow Chemical Company as a fast-set 50% solids latex sold under the name Dow DT 211 NA.

There are, of course, other polymer compositions that can be formulated and applied to provide quick setting, ionic chemistry to provide a polymer gel matrix exhibiting a high hold out property for providing a molded, coated fiber board in accordance with the invention. Thus, it is possible to prepare polymer backbones having both cationic and anionic moieties in the same polymer molecule with one of the ionic species modified by control of ambient pH. See, for example, the polymer systems described in U.S. Pat. No. 5,674,934 (Oct. 7, 1997), which is incorporated herein by reference. The polymer system is designed so that upon application of the coating, an application-dependent pH change, for example that effected by loss of carbon dioxide, reionizes the neutralized ionic species to provide an ionically-crosslinked system through the pendent anionic and cationic groups, resulting in rapid formation of an ionically-crosslinked polymer matrix or gel.

Alternatively, an ionically-crosslinked polymer gel matrix can be formed on the surface of a fiber board in performance of the methods disclosed herein by applying an anionic latex system co-sprayed, for example, using a dual channel spraying gun, with a cationic polyamine or polyimine or a cationic latex system to form a three-dimensional, ionically-crosslinked polymer gel matrix upon application to the surface of the board. Alternatively, an anionic latex system can be co-sprayed with a water soluble salt containing di- or multi-valent cationic species, for example, zinc or calcium salts, to effect ionic crosslinking and gel formation upon application to a fiber board in performance of the methods disclosed herein. The fast set latex can be substantially thermoplastic, or it can include other functional groups recognized by those skilled in the art to impart thermosetting functionality to the polymer latex.

In alternative embodiment, the primer composition is formulated to provide a quick-setting, covalently-crosslinked polymer matrix on the surface of the fiber board. The formation of such covalently-crosslinked polymer compositions preferably is achieved using two-component systems that, when combined, provide a level of covalent crosslinking reactivity sufficient to allow at least partial covalent crosslinking of the applied polymer formulation prior to pressing and deforming the board. Thus, for example, conventional two-component epoxy, urethane or ethylenically unsaturated polymers/oligomers/monomers (where a radical initiator is co-applied with the radical crosslinkable composition) can be utilized in forming a crosslinked polymer matrix on the surface of the board. The two component systems can be applied to the board, for example, as separate components through a dual channel spray gun, or they can be blended together immediately prior to application to the board and applied as a reactive homogeneous polymer composition. The nature of the reactive components of the two-component compositions is not critical, and such reactive polymer compositions can be optimized by routine experimentation to provide a level of reactivity sufficient to provide at least partial covalent crosslinking of the formulation on the surface of the board prior to molding the board according to a method disclosed herein.

In one embodiment the primer composition for use in the methods disclosed herein can have a solids content of about 30 wt. % to about 80 wt. %. In another embodiment a primer composition has a solids content of about 20 wt. % to about 70 wt. %.

The quality and functionality of the primer coating can be improved by applying a layer of a polymer-containing top coat composition over the chemically crosslinked polymer matrix on the fiber board before molding the board. The top coat preferably is a thermosetting or thermoplastic polymer latex. In one preferred embodiment of the invention the top coat composition includes a thermosetting polymer latex, for example, an acrylic latex formed from unsaturated monomers including hydroxy and/or glycidyl functionality and carboxy functionality.

The top coat typically comprises about 25% to about 60% solids and, like the primer, can be formulated using standard coating excipients including but not limited to defoamers, dispersants, wetting agents, pigments, release agents and fillers, such as silica, talc, kaolin, calcium carbonate, and the like.

A thermosetting top coat composition functions not only to improve surface hardness and mar resistance to a molded, coated board, but also to provide a thermoset skin over the primer to facilitate release of the board from the mold.

In addition to, or as an alternative to, applying a thermosetting top coat over the primer, a separate release composition (also referred to herein as a mold release composition) can be applied to facilitate release of the coated, molded board from the mold. Release compositions are well known in the art and can be formulated to include recognized release agents, alone or in combination, to provide the desired release characteristics.

A release composition including a thermoplastic or thermosetting silicone polymer or a surfactant can be applied over the primer coat before molding, preferably before steam treatment. In another embodiment, a top coat is applied over the primer and a release coat is applied over the top coat before molding, preferably before steam treatment. In still another embodiment, a primer can be applied to the fiber board, followed by steam treatment, and then followed by a top coat, a release coat, or both, before molding.

Tables 1 and 2 below contain examples of primer and top coat formulations, resepectively, believed to be useful in the methods described herein.

TABLE 1

| | |
|---|---|
| Ingredient | Wt. % |

PRIMER

| | |
|---|---|
| Fast-Set Latex (Dow DT 211 NA; 50% Total Solids) | 41.73 |
| Drew L475 (Ashland Chemical/defoamer) | 0.25 |
| ACRYSOLl I-62 (Rohm & Haas/dispersant) | 0.64 |
| SURFYNOL TG (Air Products/wetting agent) | 0.51 |
| Deionized Water | 3.94 |
| Riona RCL9 (SCM TiO₂ /pigment) | 14.71 |
| GAMACO II (Georgia Marble Co.; Dry Branch Kaolin/filler) | 35.12 |
| Neogen DGH (Dry Branch Kaolin/filler) | 3.10 |

TABLE 2

| | |
|---|---|
| Ingredient | Wt. % |

TOP COAT

| | |
|---|---|
| Low temperature, HCHO-free Thermoset Latex (40% Total | 75.0 |
| Solids; 26 parts Styrene/30 parts methylmethacrylate/30 parts | |
| butyl acrylate/10 parts glycidal methacrylate/4 parts | |
| methacrylic acid) | |
| SYLOID Z128 (W. R. Grace) silica/gloss control | 6.0 |
| ACRYSOL I-62 (Rohm & Haas) | 1.0 |
| SURFYNOL TG (Air Products) | 0.3 |
| Deionized Water | 17.45 |
| Drew L475 (Ashland Chemical) | 0.25 |

A preferred primer composition is sold under the product code 1256L10461, by The Valspar Corporation of High Point, N.C. A preferred top coat composition that serves as a mold release agent is sold under the product code 1480C10401, by The Valspar Corporation of High Point, N.C.

### EXAMPLES

The following examples are provided to illustrate the invention but are not intended to limit the scope of the invention.

### Example 1

An 18-inch by 18-inch (45.7 cm by 45.7 cm) square medium density fiberboard having a moisture content of about 5 wt. % to about 7 wt. % and a thickness of ⅛-inch nominal (about 4 mm) was coated on one side with 54 wet grams (about 17 dry grams/ft² (about 0.18 g/cm²) or about 3.5 dry mil) of the preferred primer composition (product code 1256L10461) by air spraying. The board was left to dry, and was then treated for 60 seconds in a steam chamber at approximately atmospheric pressure. The steam-treated board was then quickly loaded into a mold with upper and lower dies that formed a cavity (i.e., mold space) with a profile to create a coated door skin shown in FIG. 1 from the coated, treated board. The mold space had the same shape and dimensions as the board shown in FIG. 1 when closed to the desired caliper thickness. The temperature of the platens was 320° F. (160° C.).

In the press cycle procedure, the top die was brought down quickly at first, and then as the top die approached the coated, treated board, the rate of mold closure was reduced such that the upper die was moving very slowly as it first touched the upper, coated surface of the treated board. The dies were slowly brought together to close the mold over a time period of about 15 seconds, the mold was held closed at a caliper of about 0.125 inches (about 3.2 mm) in the planar portions of the cavity for about 30 seconds, then the pressure was released and re-applied over a period of about 30 seconds, then the mold was decompressed and opened over a period of about 15 seconds, for a total press cycle of about 90 seconds.

The door skin thus produced had a caliper thickness of about 0.125 inches (about 3.2 mm) in the planar portions and a depth of draw of about 9 mm, with a profile shown in FIG. 1. The moisture content of the coated, molded board was about 4 wt. % to about 5 wt. %. The primer coating covered the board completely, showing no signs of cracking or blistering, even in the deep-molded portions, such as those shown in FIG. 1. The coated article was suitable for staining or finish painting.

### Example 2

A high-quality coated, molded wood fiber board door skin can be produced by first coating a panel of MDF having a moisture content of about 8 wt. % and a density in the range of about 30 lb/ft³ to about 50 lb/ft³ (about 0.5 g/cm³ to about 0.8 g/cm³) with about 1 dry mil of primer composition (product code 1256L10461) by spraying. Next, coat the board with about 0.1 dry mil of top coat composition (product code 1480C10401) and then treat the coated board with steam at atmospheric pressure for about one minute. After steam treatment, quickly load the board into a heated (140-160° C.) press having a deep molding die configuration and bring the upper and lower dies together at a fast rate until just before both dies contact the board, at which time the rate of closing is lowered to a very slow rate. Finally, close the mold to the desired caliper over a period of about 10 seconds to about 30 seconds, hold the die closed at caliper for about 20 seconds to about 60 seconds, and slowly decompress and open the mold over a period of 10 seconds to about 30 seconds such that the coated, molded board has a moisture content in the range of about 4 to about 10 wt. %. This procedure will produce a high-quality, evenly primed board suitable for staining or further finishing.

The foregoing description is given for clearness of understanding only, and no unnecessary limitations should be understood therefrom, as modifications within the scope of the invention may be apparent to those having ordinary skill in the art.

What is claimed is:

1. A method of molding fiberboard comprising the steps of:
providing a sheet of fiberboard having a surface;
applying a primer composition to said surface, said primer composition including a polymer and being formulated to form a chemically crosslinked polymer matrix when applied to the board;
exposing the board to steam;
heating the board to its thermal softening point whereat the material of the fiberboard becomes plastically deformable; and
pressing the board into a desired shape.

2. The method of claim 1 wherein the heating step takes place in conjunction with the pressing step.

3. The method of claim 1, wherein the step of pressing the board into a desired shape comprises applying a first level of pressure to the board, decreasing the level of pressure applied to the board to a second level, and subsequently increasing the level of pressure applied to the board to a third level.

4. The method of claim 1, further comprising the step of forming, during the pressing step, a relief pattern or a negative relief pattern in the primed surface of the board.

5. The method of claim 1, wherein the fiber board comprises a resin binder.

6. The method of claim 5, wherein the resin binder is a melamine-urea formaldehyde.

7. The method of claim 1, wherein the primer comprises an ionically-crosslinked polymer.

8. The method of claim 7, wherein the ionically-crosslinked polymer comprises a thermoplastic polymer.

9. The method of claim 1, wherein the primer comprises an anionically-stabilized thermoplastic latex.

10. The method of claim 1, wherein the primer comprises a thermoplastic polymer latex.

11. The method of claim 1, wherein the primer comprises a thermosetting polymer latex.

12. The method of claim 1, further comprising the step of applying a polymer-containing top coat composition over the primer composition prior to the pressing step.

13. The method of claim 12, wherein the top coat composition comprises a polymer latex.

14. The method of claim 13, wherein the top coat composition comprises a thermosetting polymer latex.

15. The method of claim 1, further comprising the step of applying a mold release composition to the primed surface of the board prior to the pressing step.

16. The method of claim 15, wherein the mold release composition comprises a silicone polymer or a surfactant.
